(19) United States
(12) Patent Application Publication
(10) Pub. No.: US 2022/0403218 A1
(43) Pub. Date: Dec. 22, 2022

(54) ADHESIVE AND METHODS OF USE

(71) Applicant: SHURTAPE TECHNOLOGIES, LLC, Hickory, NC (US)

(72) Inventors: Khaled EL-TAHLAWY, Hickory, NC (US); Kevin CHOU, Hickory, NC (US); Peter ELAFROS, Hickory, NC (US); Patrick EATON, Hickory, NC (US); Ameet KULKARNI, Hickory, NC (US); Edwin FRANCO, Hickory, NC (US)

(21) Appl. No.: 17/764,930

(22) PCT Filed: Sep. 30, 2020
(86) PCT No.: PCT/US2020/053538

§ 371 Date: Mar. 29, 2022

Related U.S. Application Data
(60) Provisional application No. 63/054,506, filed on Jul. 21, 2020.
(60) Provisional application No. 62/907,894, filed on Sep. 30, 2019.

(51) Int. Cl. C09J 133/08; C09J 7/10; C09J 7/38

(52) U.S. Cl. CPC C09J 133/08; C09J 7/10; C09J 7/385

(57) ABSTRACT

An acrylic adhesive formulation that can be used for various building envelope applications. The adhesive can be coated onto various substrates such as flashing, vapor permeable membranes, vapor impermeable membranes and roofing underlayment's to make them self-adhering. The adhesive can be applied in cold temperatures from 0 degrees Fahrenheit (−18 degrees Celsius) but will maintain integrity at high temperatures without sacrificing the bonding to common construction/fenestration surfaces. The adhesive can include a blend of a plasticizer and an ultra-violet (UV) curable acrylic base polymer, which can be crosslinked upon exposure to a narrow wavelength range of ultra-violet light.

This application claims the benefit of U.S. Provisional Application Nos. 62/907,894, filed Sep. 30, 2019 and 63/054,506, filed Jul. 21, 2020, the disclosures of which are herein incorporated by reference.

### BACKGROUND

The present disclosure relates to waterproofing sheet materials employed in building construction, especially those employed in wall and roofing applications to control the movement of water, water vapor and air.

Modern building structures often make use of barrier membrane sheet materials to control the flow of moisture in and out of a building and also to control the ventilation or movement of air through a wall or roof structure. Typical membrane products are designed to be weather resistant, keeping out liquid water and resisting wind pressure.

At the same time however, some membranes may be formed so that water vapor may pass through relatively freely to avoid problems of dampness or condensation within a building or within a wall or roof structure. A number of water vapor permeable membrane products are available and combine weather resistance with water vapor permeability.

Previously known waterproofing sheets having both waterproofing and moisture permeability have been developed. One example of such moisture-permeable waterproofing sheets is flash-spun nonwoven fabrics. U.S. Pat. No. 3,169,899, for example, discloses a flash-spun nonwoven fabric. U.S. Pat. No. 3,532,589 discloses a method for producing a flash-spun nonwoven fabric. The nonwoven fabric blocks water, but allows water vapor to pass therethrough. A known example of the nonwoven fabric is commercially available under the trade designation “Tyvek” from E. I. Du Pont de Nemours and Company, Wilmington, Del. USA. It is beneficial for such moisture-vapor permeable waterproofing sheets to pass ASTM D-1970/D-1970M or similar modified tests such as Modified Test 1 of ASTM D-1970/D-1970M, Modified Test 2 of ASTM D-1970/D-1970M, or Modified Test 3 of ASTM D-1970/D-1970M. In addition to building wrap, the present disclosure has usefulness in association with at least roof underlayment and flashing tape.

Typical membrane sheeting is attached to a wall or roof structure by means of mechanical fasteners such screws or nails or by use of an adhesive. It is beneficial for the adhesives provided on barrier membranes to provide robust adhesion in a variety of conditions. For example, it is beneficial for such an adhesive to adhere to wet substrates over a wide temperature range such as 0° F. to 150° F. The present adhesive composition achieves those objectives.

### BRIEF DESCRIPTION

Various details of the present disclosure are hereinafter summarized to provide a basic understanding. This summary is not an extensive overview of the disclosure and is neither intended to identify certain elements of the disclosure, nor to delineate scope thereof. Rather, the primary purpose of this summary is to present some concepts of the disclosure in a simplified form prior to the more detailed description that is presented hereinafter.

According to a first embodiment, an acrylic (alternatively known as an acrylate polymer) adhesive formulation that can be used for various building construction and/or envelope applications is provided. The adhesive can be coated onto various substrates such as flashing tape, vapor permeable membranes, vapor impermeable membranes and roofing underlayments, sealing tape, double coated tape, seaming tape, and flexible/semi-flexible substrates/barriers to make them self-adhering. The adhesive can be applied in cold temperatures from 0 degrees Fahrenheit (−18 degrees Celsius) but will maintain integrity at high temperatures without sacrificing the bonding to common construction/fenestration surfaces. No primer is needed to assist in adhesion. The adhesive can include a blend of a plasticizer and an ultra-violet (UV) curable acrylic base polymer, which can be crosslinked upon exposure to a narrow wavelength range of ultra-violet light.

According to a second embodiment, an adhesive composition comprising a UV curable acrylic polymer having a molecular weight between about 150,000 and 300,000 grams/mol or between about 170,000 and 250,000 grams/mol and 1-50, or 2-30 or 5-25 or 8-20, wt % of a plasticizer having a molecular weight between about 200 and 1000 grams/mol. or 300 and 700 grams/mol. or 400 and 600 grams/mol is provided.

According to a third embodiment, the adhesive comprises a non-reactive liquid plasticizer, resin and/or tackifier (e.g. 8-20% by weight) having a first Tg and a UV reactive acrylic polymer (e.g. 80-92% by weight) having a Tg higher than the first Tg. One example of a liquid plasticizer is Citroflex A4, commercially available from Vertellus. One example of a UV reactive acrylic polymer is AcResin 260, commercially available from BASF Corporation. The UV reactive acrylic polymer can have a weight average molecular weight (Mw) of at least 150,000 or at least 170,000 grams/mol as measured by Gel Permeation Chromotography (GPC), for example, a Walters Breeze II system with Styralgel, HR1+E1 column using 30 mg of adhesive dissolved in 10 ml of THF

According to a further embodiment, a barrier article for use in building construction is provided. The article comprises a flexible substrate that is at least substantially impermeable to water. The substrate is at least 60 cm in width, 5 m in length, and 0.001 inches in thickness. The substrate includes a pressure sensitive adhesive deposited on at least one major surface. The adhesive can be in the form of a repeating pattern that covers less than 100% of the major surface. The adhesive can be comprised of a mixture of UV curable acrylic polymer and at least 8 wt % plasticizer. The adhesive can be formed using batch or continuous/in-process mixing to combine the constituents.

According to another embodiment, an adhesive composition comprising a UV curable polymer having a molecular weight of at least 150,000 g/mol with a λ max of 200-360 nm or 250-260 nm and a plasticizer that absorbs less than 5% of UV radiation at λ of 200-360 nm or 250-260 nm is provided.

In an alternative embodiment, the adhesive can comprise a non-reactive liquid plasticizer, resin and/or tackifier (e.g. 1-50 wt. % or 2-30 wt. % or 5-25 wt. % or 8-20% by weight) having a first Tg and a UV reactive acrylic polymer (e.g. 70-99% by weight) having a Tg higher than the first Tg. The inclusion of a minor amount of a low (i.e., lower than the primary plasticizer) Tg plasticizer, resin or tackifier can advantageously provide desirable adhesive properties in a low temperature environment. The adhesive polymer can have a number average molecular weight (Mn) between 50,000 and 65,000 grams/mol and/or a weight average molecular weight (Mw) of between 100,000 and 300,000 grams/mol or 150,000 and 300,000 grams/mol or 100,000 and 200,000 grams/mol as measured by Gel Permeation Chromotography (GPC), for example, a Walters Breeze II system with Styralgel, HR1+E1 column using 30 mg of adhesive dissolved in 10 ml of THF.

The adhesive of this disclosure is suitable for use in building construction materials such as vapor permeable and impermeable barriers, flashing tape, sealing tape, transfer film, double coated tape, roof underlayment and flexible/semi-flexible substrates. The adhesive can be applied to the building material in a repeating or random pattern that covers 100% or less of a surface at a selected ratio to impart controlled permeability, adhesion and functionality.

The adhesive can be formed using batch or continuous/in-process mixing to combine the components. The adhesive inclusive article can be formed by transfer coating the cured UV pressure sensitive adhesive onto said article, or by direct coating and curing the pressure sensitive adhesive on the article. The transfer coating substrate can form a release liner on the article. The transfer coating substrate can be removed and replaced with a release liner of an alternate composition. The article can be treated to allow self-winding, wherein the transfer coating substrate is removed after UV cure of the adhesive.

According to a further embodiment, an adhesive composition comprising a UV curable polymer having a shear viscosity (Pa·s) of less than 17 at 240° F. and less than 10 at 280° F. in combination with 5-30 wt. % or 5-25 wt. % of a plasticizer having a molecule weight between about 200 and 600 grams/mol is provided.

According to another embodiment, an article comprising flashing tape, vapor barrier or roof underlayment including 100% adhesive coverage using the presently disclosed adhesive on an adhesive inclusive surface is provided. The article can be vapor permeable after attachment to a building substrate. For example, in the case of a permeable non-woven polyolefin substrate (optionally microporous), the adhesive inclusive article can include (i) at least 3 mils of adhesive and have an ASTM E96B permeability of at least 40, (ii) at least 5 mils of adhesive and have a ASTM E96B permeability of at least 25, or (iii) at least 8 mils of adhesive and have an ASTM E96B permeability of at least 10 or 15.

According to an additional embodiment, a release liner comprised of paper, polymer or other material is provided. The adhesive inclusive release liner is one of self-wound or linered to serve as an adhesive transfer product.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a perspective view of a representative barrier laminate;

FIG. 2 is an enlarged sectional view taken along lines 2-2 of FIG. 1;

FIG. 3 is a fragmentary view of a building housing the barrier laminate of FIG. 1 applied thereto;

FIG. 4 is a front plan view of an exemplary adhesive application pattern;

FIG. 5 is a graphical depiction of shear viscosity of representative UV curable polymers;

FIG. 6 is graphical depiction of UV absorbance of various resin/plasticizer blends; and

FIG. 7 illustrates hot shear performance of an AC resin/Citroflex A4 adhesive blend.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure.

The singular forms “a,” “an,” and “the” include plural referents unless the context clearly dictates otherwise.

As used herein, the terms about, generally and substantially are intended to encompass structural or numerical modifications which do not significantly affect the purpose of the element or number modified by such term. The terms “about” or “approximately” with reference to a numerical value or a shape means +/−ten percent of the numerical value or property or characteristic, but expressly includes the exact numerical value. The term “substantially” with reference to a property or characteristic means that the property or characteristic is exhibited to a greater extent than the opposite of that property or characteristic is exhibited. For example, a plasticizer that is “substantially” transparent refers to a material that transmits more radiation (e.g. UV light) than it fails to transmit (e.g. absorbs and reflects).

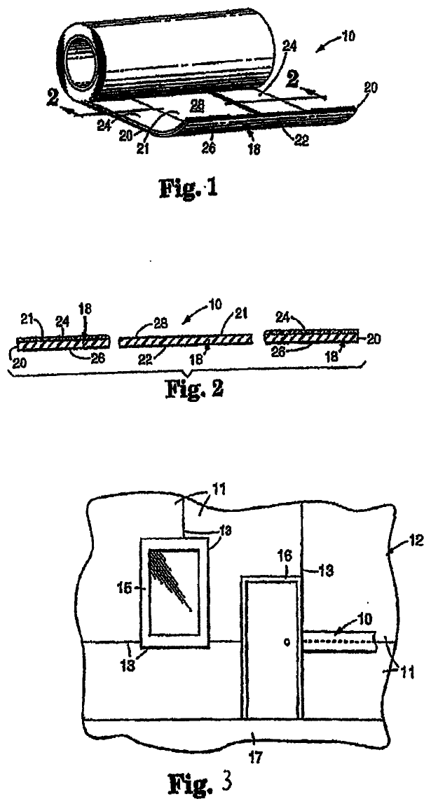

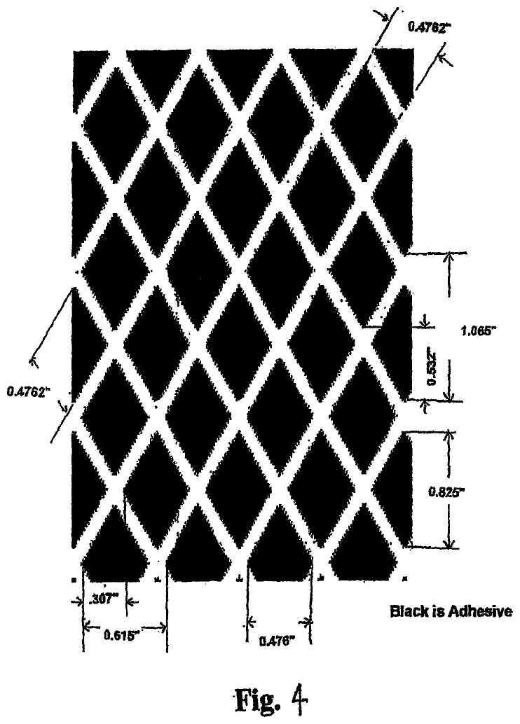

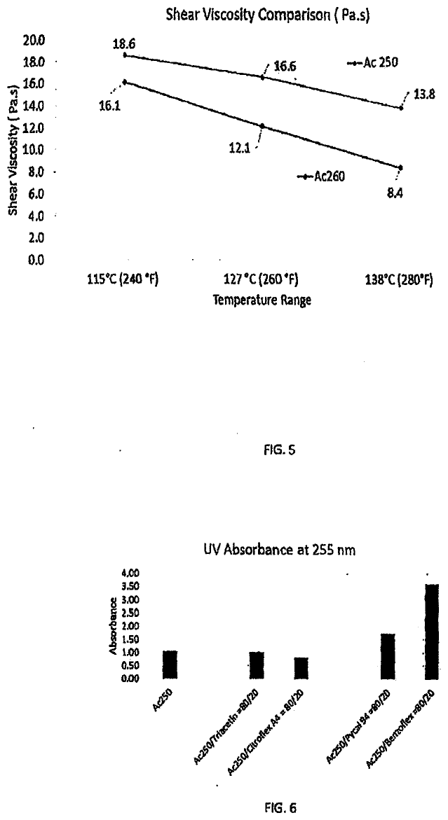

Referring now to FIGS. 1 and 2 a first embodiment of a barrier laminate is designated by the reference numeral 10. The barrier laminate 10 is adapted for attachment to the outer surface of a structure, such as a house 12 illustrated in FIG. 3. The sheathing 11 is attached prior to attachment of siding to cover joints 13 between structural members and between adjacent sheathing members 11, window frame 15, door frame 16, sill 17, corners, cantilevers, raised heel trusses and band joists, etc. assembled to form the structure or house 12. Although a house sidewall is depicted in FIG. 3, the subject flexible barrier underlayment is equally suitable for use with roofs and commercial buildings.

The barrier laminate 10 comprises a flexible elongate barrier layer 18 having opposite edges 20 and opposite first and second major surfaces 21 and 22. The barrier layer 18 can be porous material so that the barrier layer 18 has minute passageways between its major surfaces 21 and 22 affording passage of water vapor between its major surfaces while restricting the passage of liquid water and air between its major surfaces 21 and 22. The barrier laminate 10 also includes a layer 24 of discontinuous pressure sensitive adhesive for adhering the barrier layer 18 to structural members. Particularly, adhesive portions 24 are separated by portion 28 which is free of adhesive to preclude interference of the adhesive with movement of the water vapor through the barrier layer 18.

The sheet can be water impermeable and water vapor permeable or impermeable. A water vapor permeable sheet may be microporous, microperforated or some other type of vapor permeable sheet or film. A microporous sheet can be a non-perforated continuous microfibre web with microscopic pores large enough for moisture vapor to pass through, but small enough to resist air and liquid water. Microperforated membranes depend on mechanical pin-perforations and/or film laminations to build in properties.

Suitable microporous sheets can be spun bonded or fibrous bonded polyolefin as described in U.S. Pat. Nos. 3,532,589 and 5,972,147, the disclosures of which are herein incorporated by reference. Exemplary polyolefins are polyethylene and polypropylene. One commercially available microporous sheet is sold under the trade-mark Tyvek. Other suitable microporous sheets include oriented polymeric films as described in U.S. Pat. No. 5,317,035, herein incorporated by reference, which comprise ethylene-propylene block copolymers. One exemplary film is commercially available from RKW Group under the trademark Aptra.

The sheets may be reinforced with various types of scrim materials or may be laminated to other sheets or films, such as non-woven polypropylene or non-woven polyester for the purpose of improving strength and other physical properties. Suitable sheet material could be multi-layer laminates including a microporous or microperforated layer (e.g. polytheylene). An example of such a sheet material is Utraperm Lite or Ultraperm Max supplied by Industrial Textiles and Plastics, United Kingdom.

Typical water barrier membranes will be supplied in roll form and have a width (cross-direction or XD) in the range of about 30 to 250 cm, more typically about 60 to 160 cm; and a length (machine direction or MD) of about 5 to 80 m, more typically about 15 to 40 m. In general, the membrane will typically have a thickness of 0.001 to 0.008 or 0.001 to 0.025 inches.

Other suitable applications for the subject adhesive include use with roof underlayment and flashing tapes.

A roof underlayment can generally be described as a sheet material which is interposed between a roof deck or other substrate of a building structure and a bottom surface of a roofing membrane. The underlayment sheet material provides both resistance to water and can have a retardant effect to the spread of fire. Additionally, it may provide a temporary waterproofing roof membrane without any other membrane material. Exemplary roof underlayment's are described in U.S. Pat. Nos. 6,641,896; 9,415,563; 9,702,148, the disclosures of which are herein incorporated by reference.

With respect to flashing tape, it is noted that many construction practices commonly require the installation of a self-adhered flashing tape over the fenestration joints i.e. the joint between penetrations (such as windows, doors, ventilation ducts, etc.) and the building structure as well as on various surfaces adjacent to or within the fenestration to seal out water. These flashing tapes can be applied prior to installation of the siding or trim. Nails used to attach the siding or trim to the building structure are often installed right through the flashing tape and the flashing tape can help seal such punctures. Exemplary flashing tapes are described in US Publications 2012/0085063 and 2013/0139953, the disclosures of which are herein incorporated by reference.

The adhesive can be deposited onto the substrate carrier sheet by any means. One exemplary process is by transfer, such as through the use of an engraved roll. One suitable example is a gravure roll. One advantage of using a gravure roll is the ability to deposit adhesive onto the substrate carrier sheet at low application rates that can be accurately controlled in terms of thickness and coverage area. This process is described in PCT/US2019/029807, the disclosure of which is herein incorporated by reference.

Alternatively, substrate transfer coating can be employed wherein the adhesive is first to spread onto a release substrate to form a film. The adhesive can be UV cured on the release substrate and then the at least partially cured adhesive film can be laminated to the building enclosure substrate (e.g., the roof underlayment, vapor barrier, or flashing tape). It may be advantageous to cure the adhesive on the transfer substrate to avoid damaging the working material. It is contemplated that the release substrate can then form a release liner on the adhesive inclusive building enclosure substrate. The presence of the release liner can allow the building enclosure substrate to be stacked or rolled upon itself.

In some embodiments, the pressure sensitive adhesive is discontinuously disposed in a patterned manner. In some embodiments, the pressure sensitive adhesive covers 10% to 90% of the surface. The adhesive may suitably be applied so as to cover between 25% and 90% of the area, or between 50% and 80% of the area, to obtain the optimum balance of adhesion and vapor permeance in the sheet. In some embodiments, the pressure sensitive adhesive is a permeable pressure sensitive adhesive that is continuously disposed on the entire surface.

An adhesive may be applied at a thickness of 0.001 inches to 0.1 inch, or a thickness of 0.003 inches to 0.025 inches, or a thickness of 0.005 inches to 0.02 inches. The adhesive may be protected with a strippable release sheet or liner to enable packaging in rolls. Suitable release sheets are paper sheet, having a silicone release surface is coating and some treated plastic films. Alternatively, the back side major surface of the barrier article may include an overlaid or overcoated low surface energy release layer or low adhesion back size.

From a production standpoint, the adhesives can be the hot melt type. One example of a suitable adhesive composition is a polyacrylate. This is an addition polymer obtainable by free-radical polymerization of acrylic monomers, which are understood to include methacrylic monomers, with or without further, copolymerizable monomers. The polyacrylate can be composed of at least 40% by weight, or at least 60% by weight, or at least 80% by weight, of C_{′}-C_{″}-alkyl (meth)acrylates. For example, C₁-C₁₈, alkyl (meth)acrylates, examples being methyl (meth)acrylate, ethyl (meth)acrylate, n-butyl (meth)acrylate, 2-ethylhexyl(meth)acrylate are suitable.

The acrylic or methacrylic ester polymers may be prepared by polymerizing an alkyl or hydroxyalkyl acrylate or methacrylate ester, optionally, with one or more nitrogen containing monomers and/or a carboxylic acid. The acrylate or methacrylate esters include those having from about 1 to about 24, or from about 2 to about 18, or from about 4 to about 16 carbon atoms in the ester group. The alkyl acrylate and methacrylate esters include without limitation 2-ethyl hexyl acrylate, isooctyl acrylate, butylacrylate, sec-butyl acrylate, methyl butyl acrylate, 4-methyl2-pentyl acrylate, isodecyl methacrylate and their hydroxy substituted analogs, and mixtures thereof.

The polymers may include other co-polymerizable monomers. Typically, these monomers are present in an amount from 0% to about 33%, or from about 1% to about 20%, or from about 3% to about 15% by weight. These other monomers can be selected to tailor the glass transition temperature for the polymer. Other monomers include polystyryl ethyl methacrylate, acetoacetoxy ethyl methacrylate, alpha olefins (e.g. C2-8 alpha-olefins), such as ethylene, propylene and butylene, and vinyl esters of alkanoic acids containing more than three carbon atoms. Examples of further monomers of which the adhesive may be composed are vinyl esters-of carboxylic acids containing up to 20 carbon atoms, vinylaromatics having up to 20 carbon atoms, ethylenically unsaturated nitriles, vinyl halides, vinyl ethers of alcohols containing 1 to 10 carbon atoms, aliphatic hydrocarbons having from 2 to 8 carbon atoms and 1 or 2 double bonds, or mixtures of these monomers.

The polymer may be synthesized in solution, emulsion, and/or bulk polymerization.

The polymer can be crosslinkable with UV light. For UV crosslinking the composition of the invention may have a photoinitiator added to it. Alternatively, the photoinitiator may be attached to the polymer.

By exposure to high-energy light, especially UV light, the photoinitiator brings about crosslinking of the polymer, for example by means of a chemical grafting reaction of the photoinitiator with a spatially adjacent polymer chain. Advantageous light wavelengths are about 200 to 360 nm. An advantageous energy level is between about 20 mJ/cm² and 100 mJ/cm².

Crosslinking may take place by insertion of a carbonyl group of the photoinitiator into an adjacent C H bond, to form a CC OH group. The composition can contain from 0.0001 to 1 mol, or from 0.0002 to 0.1 mol, from 0.0003 to 0.01 mol, of the photoinitiator, or of the group which acts as a photoinitiator and is attached to the polymer, per 100 g of polyacrylate. The photoinitiator comprises, for example, acetophenone, benzophenone, benzoin ethers, benzyl dialkyl ketals, or derivatives thereof.

The photoinitiator can be incorporated into the polymer chain by means of free-radical copolymerization. For this purpose the photoinitiator can include an acrylic or methacrylic group. Suitable copolymerizable photoinitiators are acetophenone derivatives or benzophenone derivatives containing at least one, ethylenically unsaturated group. The ethylenically unsaturated group is preferably an acrylic or methacrylic group. The ethylenically unsaturated group may be attached directly to the phenyl ring of the acetophenone or benzophenone derivative. A spacer group can be present between the phenyl ring and the ethylenically unsaturated ring.

The adhesion of the polymer adhesives can be poor at low temperatures because of the storage modulus and loss modulus are too high for the adhesive at these temperatures to flow onto any surface. Based on dynamic mechanical analysis the glass transition temperature (Tg) of an exemplary UV curable acrylic base polymer is −39 degrees Celsius and the Dahlquist Temperature is −6 degrees Celsius. The adhesive temperature can be above its's Dahlquist temperature to provide enough tack and flow onto a surface.

To reduce the Tg and the Dalhquist of the UV curable acrylic base polymer, a plasticizer can be added. The plasticizer is selected to provide (1) sufficient chemical compatibility to the acrylic base polymer, so significant phase separation does not occur causing loss in adhesive properties and the resulting mixture is optically clear for proper UV curing, (2) sufficiently low volatility, so that plasticizer migration during storage of the building envelope is kept at a minimum to avoid loss in adhesive properties over time, (3) refractive index similar to the acrylic base polymer to allow for proper UV curing of the base acrylic polymer, (4) low molecular weight in order for the plasticizer molecules to diffuse between the acrylic base polymer during mixing in a continuous mixer (short mixing cycle for fast production rates) and (5) low toxicity and low odor for environment, health and safety.

The plasticizer can be a high-boiling solvent or softening agent, usually liquid. The molecular weight can be between 200 g/mol and 600 g/mol. The plasticizers may be adipate, phosphate, benzoate or phthalate esters, polyalkylene oxides, sulfonamides, etc. The plasticizers can be selected from the group consisting of esters of C2-C4 carboxylic acids with C2-C5 alkyl alcohols having 2-4 hydroxyl groups, for example, ethylene glycol, propylene glycol, glycerine, trimethylolpropane, or pentaerythritol, optionally ethoxylated, acetates of C2-05, such as, for example, glycerine triacetate or ethylene glycol diacetate. The plasticizers include but are not limited to DOA plasticizer (Dioctyl adipate), TEG-EH plasticizer (Triethylene glycol di-2-ethylhexanoate), TXIB plasticizer (2, 2, 4, -trimethyl-1,3-pentanediol diisobutyrate), DEP plasticizer (Diethyl phthalate), DOTP plasticizer (Dioctyl terephthalate), DMP plasticizer (Dimethyl phthalate), DOP plasticizer (Dioctyl phthalate), DBP plasticizer (Dibutyl phthalate), polyethylene oxide, toluenesulfonamide, dipropylene glycol benzoate, and the like. Particular examples include, trioctyl trimellitate; adipates such as dimethyl adipate; and benzoates such as diethylene glycol dibenzoate. Further exemplary plasticizers include citric acid esters, acetates, monomeric adipates, polymeric ester adipates, trimellitates and trimaleates. Commercially available citric acid esters are CITROFLEX A-4, CITROFLEX B6 and CITROFLEX A-2 by Vertellus. Commercially available acetates are TRIACETIN by Eastman Chemical. Commercially available polymeric ester and monomeric adipates are ADMEX sold by Eastman chemical. Suitable Trimellitates sold commercially as TOTM by Hallstar Company.

The adhesive of the present disclosure may also include crosslinking enhancer(s) to improve the high temperature performance and the curing consistency at higher coating weights (e.g. 6-10 mils). Exemplary crosslinking enhancers include SR 351 and SR 355 from Sartomer.

Tackifying resins may be useful in the adhesive and may include the aliphatic, aromatic or mixed aliphaticaromatic hydrocarbon resins, and hydrogenated derivatives thereof, and terpenes and terpene derivatives having a Ring and Ball softening point of between about 70° C. and about 150° C. One skilled in the art would recognize that these tackifying resins are available with differing levels of hydrogenation.

Paraffin waxes may be useful in the adhesive and include those having melting points in the range of about 130 to 200° F. (54° C. to 193° C.), such as, for example, PACEMAKER from Citgo, and R-2540 from Moore and Munger; and low melting point synthetic microcrystalline or Fischer-Tropsch waxes having a melting point of less than about 180° C. The most preferred wax is paraffin wax with a melting point of 150° C.

The adhesives of the invention can also contain a stabilizer or antioxidant. Among the applicable stabilizers or antioxidants included herein are high molecular weight hindered phenols and multifunctional phenols such as sulfur and phosphorous-containing phenol. Hindered phenols are well known to those skilled in the art and may be characterized as phenolic compounds which also contain sterically bulky radicals in close proximity to the phenolic hydroxyl group thereof. In particular, tertiary butyl groups generally are substituted onto the benzene ring in at least one of the ortho positions relative to the phenolic hydroxy group. The presence of these sterically bulky substituted radicals in the vicinity of the hydroxyl group serves to retard its stretching frequency, and correspondingly, its reactivity; this hindrance thus providing the phenolic compound with its stabilizing properties. Representative hindered phenols include; 1,3,5-trimethyl 2,4,6-tris (3,5-di-tert-butyl-4-hydroxybenzyl) benzene; pentaerythrityl tetrakis-3(3,5-di-tert-butyl-4-hydroxyphenyl)propionate; n-octadecyl-3(3,5-di-tert-butyl4-hydroxyphenyl)-propionate; 4,4′-methylenebis (2,6-tertbutylphenol); (6-tert-butyl-o-cresol); 2,6-ditertbutylphenol; 6-(4-hydroxyphenoxy)-2,4-bis(n-octyl-thio)-1,3,5 triazine; di-n-octylthio)ehtyl 3,5-di-tert-butyl-4-hydroxy-benzoate; and sorbitol hexa[3-(3,5-di-tert-butyl-4-hydroxyphenyl)-propionate]. Commercially available. antioxidants include the hindered phenols known as IRGANOX, and available from Ciba-Geigy.

Other additives such as pigments and dyestuffs conventionally added to hot melt adhesives for various end uses may also be incorporated in minor amounts, i.e., up to about 10% by weight, into the formulations of the present invention.

The adhesive compositions can be prepared by blending the components in the melt at elevated temperature until a homogeneous blend is obtained. Various methods of blending are known to the art and any method that produces a homogeneous blend is satisfactory.

In the situation where cold temperature installation of the flashing tape, vapor membrane or roofing underlayment, etc. is necessary, it has been found that a particular molecular weight range of the UV curable acrylic polymer may be advantageous. Moreover, two UV curable polymers were evaluated including AcResin 250 and AcResin 260. Molecular weight was measured by Gel Permeation Chromotography (GPC), for example, a Walters Breeze II system with Styralgel, HR1+E1 column using 30 mg of adhesive dissolved in 10 ml of THF. The results were as follows:

Molecular Weight Comparison

| Sample | Retention | Mn | Mw | MP | Mz | | Area |
|---|---|---|---|---|---|---|---|
| Name | Time (min) | (Daltons) | (Daltons) | (Daltons) | (Daltons) | PDI | (%) |
| AcResin | 13.7 | 58659 | 209159 | 110814 | 595057 | 3.57 | 96.3 |
| 250 | 18.3 | 350 | 359 | 336 | 370 | 1.03 | 3.7 |
| AcResin | 13.8 | 55660 | 195819 | 106944 | 541203 | 3.52 | 97.6 |
| 260 | 18.3 | 350 | 360 | 336 | 373 | 1.03 | 2.4 |

AcResin 260 has a slightly lower molecular weight Mn (number average molecular weight) & Mw (weight average molecule weight) compared to AcResin 250. For example, the weight average molecular weight for AcResin 260 was 196,000 while that of AcResin 250 was 209,000 grams/mol. ACResin 260 demonstrated significantly lower shear viscosity values than ACResin 250 at 240° F., 260° F. and 280° F.

Shear viscosity of the UV curable polymers was compared in a capillary Rheometer at various temperatures. Shear viscosity at shear rate of 5000 (1/s) using a RH7 capillary rheometer from Malvern Instruments is shown in FIG. 5.

It is contemplated that the article, such as the flashing tape, vapor barrier or roof underlayment will include 100% adhesive coverage on an adhesive inclusive surface. The article can be vapor permeable in a state of attachment to a building structure because the adhesive can be at least partially vapor permable.

### Adhesive Composition Examples

AAMA 711 is a building standard for flashing tapes. The adhesion to a variety of surfaces is preferably at least 1.5 lbs/in. Oriented Strand Board (OSB) is a common fenestration surface but one of the most difficult to adhere to because of its low surface energy and rough surface. A typical commercial UV curable acrylic base polymer properties are shown below at various UV dosages. The base polymer adhesive of 5 mil thickness is laminated to a flashing of 8 mil thickness. The adhesion to OSB at room temperature using just the base polymer adhesive meets the criteria but does not adhere at well 0 or 10 degrees Fahrenheit.

| | Transfer | | | 90° Peel | 90° Peel | 90° Peel | |
|---|---|---|---|---|---|---|---|
| | Film, or | | 90° Peel | adhesion | adhesion | adhesion | |
| | laminated | UV Cure | adhesion | at 10° F. | at 0° F. | at 73° F. | Shear to |
| | to | Dosage | Specification | to OSB | to OSB | to OSB | Steel |
| Adhesive | Substrate | (mJ/cm2) | (Lbs) | (Lbs) | (Lbs) | (Lbs) | (minutes) |
| UV curable Acrylic | 8 mil Flashing | 50 | >1.5 | 0.43 | 0.03 | 2.11 | 54.0 |
| Base Polymer | | | | | | | |
| UV curable Acrylic | 8 mil Flashing | 70 | >1.5 | 0.42 | 0.03 | 2.43 | 475.7 |
| Base Polymer | | | | | | | |
| UV curable Acrylic | 8 mil Flashing | 90 | >1.5 | 0.36 | 0.02 | 2.07 | — |
| Base Polymer | | | | | | | |
| UV curable Acrylic | 8 mil Flashing | 120 | >1.5 | 0.34 | 0.02 | 2.04 | 451.0 |
| Base Polymer | | | | | | | |

To achieve improved low temperature positioning a plasticizer was blended with a curable acrylic base polymer. The blended adhesive is of 5 mil thickness and is laminated to an 8 mil flashing. The adhesive is subjected to varying UV dosages to cure the UV curable acrylic base polymer. Increasing weight % of the plasticizer increased the adhesion both at 0 and 10 degrees Fahrenheit.

| | Transfer | | | 90° Peel | 90° Peel | 90° Peel | |
|---|---|---|---|---|---|---|---|
| | Film, or | | 90° Peel | adhesion | adhesion | adhesion | |
| | laminated | UV Cure | adhesion | at 10° F. | at 0° F. | at 73° F. | Shear to |
| | to | Dosage | Specification | to OSB | to OSB | to OSB | Steel |
| Adhesive | Substrate | (mJ/cm2) | (Lbs) | (Lbs) | (Lbs) | (Lbs) | (minutes) |
| Ac250/Citroflex | 8 mil Flashing | 50 | >1.5 | 0.90 | 0.41 | 2.58 | 35.0 |
| A-4 = 94/6 | | | | | | | |
| Ac250/Citroflex | 8 mil Flashing | 70 | >1.5 | 1.07 | 0.56 | 3.16 | 211.0 |
| A-4 = 94/6 | | | | | | | |
| Ac250/Citroflex | 8 mil Flashing | 90 | >1.5 | 0.61 | 0.36 | 2.76 | 609.0 |
| A-4 = 94/6 | | | | | | | |
| Ac250/Citroflex | 8 mil Flashing | 120 | >1.5 | 0.66 | 0.41 | 2.61 | 796.5 |
| A-4 = 94/6 | | | | | | | |
| Ac250/Citroflex | 8 mil Flashing | 50 | >1.5 | 1.63 | 1.03 | — | — |
| A-4 = 90/10 | | | | | | | |
| Ac250/Citroflex | 8 mil Flashing | 70 | >1.5 | 1.81 | 0.77 | X | — |
| A-4 = 90/10 | | | | | | | |
| Ac250/Citroflex | 8 mil Flashing | 90 | >1.5 | 1.85 | 0.79 | — | — |
| A-4 = 90/10 | | | | | | | |
| Ac250/Citroflex | 8 mil Flashing | 120 | >1.5 | 1.75 | 0.69 | — | — |
| A-4 = 90/10 | | | | | | | |
| Ac250/Citroflex | 8 mil Flashing | 50 | >1.5 | 2.32 | 0.95 | 3.53 | — |
| A-4 = 88/12 | | | | | | | |
| Ac250/Citroflex | 8 mil Flashing | 70 | >1.5 | 1.66 | 1.05 | — | — |
| A-4 = 88/12 | | | | | | | |
| Ac250/Citroflex | 8 mil Flashing | 90 | >1.5 | 1.52 | 1.10 | 5.21 | 37.2 |
| A-4 = 88/12 | | | | | | | |
| Ac250/Citroflex | 8 mil Flashing | 120 | >1.5 | 1.57 | 1.07 | 3.95 | 168.6 |
| A-4 = 88/12 | | | | | | | |
| Ac250/Citroflex | 8 mil Flashing | 50 | >1.5 | 2.30 | 0.97 | 3.70 | 3.1 |
| A-4 = 86.5/13.5 | | | | | | | |
| Ac250/Citroflex | 8 mil Flashing | 70 | >1.5 | 2.31 | 1.20 | — | — |
| A-4 = 86.5/13.5 | | | | | | | |
| Ac250/Citroflex | 8 mil Flashing | 90 | >1.5 | 2.35 | 1.11 | 4.63 | 19.8 |
| A-4 = 86.5/13.5 | | | | | | | |
| Ac250/Citroflex | 8 mil Flashing | 120 | >1.5 | 1.70 | 1.31 | 4.28 | 52.2 |
| A-4 = 86.5/13.5 | | | | | | | |
| Ac250/Citroflex | 8 mil Flashing | 50 | >1.5 | 2.08 | 2.04 | 2.78 | 0.9 |
| A-4 = 83/17 | | | | | | | |
| Ac250/Citroflex | 8 mil Flashing | 70 | >1.5 | 2.08 | 1.74 | 3.08 | 2.8 |
| A-4 = 83/17 | | | | | | | |
| Ac250/Citroflex | 8 mil Flashing | 90 | >1.5 | 2.31 | 1.70 | 3.11 | 7.6 |
| A-4 = 83/17 | | | | | | | |
| Ac250/Citroflex | 8 mil Flashing | 120 | >1.5 | 2.14 | 1.89 | 2.75 | 11.6 |
| A-4 = 83/17 | | | | | | | |

The table below shows the use of CITROFLEX B-6 citric acid ester plasticizer at various weight percentages subject to varying UV dosages. The blend consists of the plasticizer and UV curable acrylic base polymer. Increasing weight % of the plasticizer increased the adhesion both at 0 and 10 degrees Fahrenheit.

| | Transfer | | | 90° Peel | 90° Peel | 90° Peel | |
|---|---|---|---|---|---|---|---|
| | Film, or | | 90° Peel | adhesion | adhesion | adhesion | |
| | laminated | Cure | adhesion | at 10° F. | at 0° F. | at 73° F. | Shear to |
| | to | Dosage | Specification | to OSB | to OSB | to OSB | Steel |
| Adhesive | Substrate | (mJ/cm2) | (Lbs) | (Lbs) | (Lbs) | (Lbs) | (minutes) |
| Ac250/Citroflex | 8 mil Flashing | 50 | >1.5 | 0.85 | 0.38 | 2.78 | 15.5 |
| B-6 = 92/8 | | | | | | | |
| Ac250/Citroflex | 8 mil Flashing | 70 | >1.5 | 1.05 | 0.38 | 2.91 | 42.5 |
| B-6 = 92/8 | | | | | | | |
| Ac250/Citroflex | 8 mil Flashing | 90 | >1.5 | 0.82 | 0.38 | 2.57 | 163.0 |
| B-6 = 92/8 | | | | | | | |
| Ac250/Citroflex | 8 mil Flashing | 120 | >1.5 | 1.32 | 0.37 | 2.60 | 360.0 |
| B-6 = 92/8 | | | | | | | |
| Ac250/Citroflex | 8 mil Flashing | 50 | >1.5 | 1.12 | 1.27 | 1.63 | 2.6 |
| B-6 = 90/10 | | | | | | | |
| Ac250/Citroflex | 8 mil Flashing | 70 | >1.5 | 1.31 | 0.98 | 1.80 | 4.5 |
| B-6 = 90/10 | | | | | | | |
| Ac250/Citroflex | 8 mil Flashing | 90 | >1.5 | 1.44 | 0.79 | 1.85 | 15.7 |
| B-6 = 90/10 | | | | | | | |
| Ac250/Citroflex | 8 mil Flashing | 120 | >1.5 | 1.20 | 0.66 | 1.75 | 28.7 |
| B-6 = 90/10 | | | | | | | |
| Ac250/Citroflex | 8 mil Flashing | 50 | >1.5 | 1.84 | 1.08 | 2.32 | 1.9 |
| B-6 = 88/12 | | | | | | | |
| Ac250/Citroflex | 8 mil Flashing | 70 | >1.5 | 2.78 | 0.70 | 1.67 | 4.2 |
| B-6 = 88/12 | | | | | | | |
| Ac250/Citroflex | 8 mil Flashing | 90 | >1.5 | 1.53 | 0.78 | 1.57 | 6.2 |
| B-6 = 88/12 | | | | | | | |
| Ac250/Citroflex | 8 mil Flashing | 120 | >1.5 | 1.95 | 1.05 | 1.52 | 12.2 |
| B-6 = 88/12 | | | | | | | |
| Ac250/Citroflex | 8 mil Flashing | 50 | >1.5 | 2.19 | 1.42 | 2.30 | 1.1 |
| B-6 = 86.5/13.5 | | | | | | | |
| Ac250/Citroflex | 8 mil Flashing | 70 | >1.5 | 1.53 | 1.15 | 2.30 | 2.5 |
| B-6 = 86.5/13.5 | | | | | | | |
| Ac250/Citroflex | 8 mil Flashing | 90 | >1.5 | 1.51 | 1.35 | 2.34 | 3.2 |
| B-6 = 86.5/13.5 | | | | | | | |
| Ac250/Citroflex | 8 mil Flashing | 120 | >1.5 | 2.37 | 1.10 | 1.71 | 4.0 |
| B-6 = 86.5/13.5 | | | | | | | |
| Ac250/Citroflex | 8 mil Flashing | 50 | >1.5 | 2.42 | 1.15 | 2.08 | 0.7 |
| B-6 = 83/17 | | | | | | | |
| Ac250/Citroflex | 8 mil Flashing | 70 | >1.5 | 2.36 | 1.81 | 2.08 | 0.8 |
| B-6 = 83/17 | | | | | | | |
| Ac250/Citroflex | 8 mil Flashing | 90 | >1.5 | 2.10 | 0.92 | 2.31 | 1.2 |
| B-6 = 83/17 | | | | | | | |
| Ac250/Citroflex | 8 mil Flashing | 120 | >1.5 | 2.08 | 2.07 | 2.14 | 1.2 |
| B-6 = 83/17 | | | | | | | |

The table below shows the use of Admex 525 polymeric adipate plasticizer at various weight percentages subject to varying UV dosages to cure the base acrylic polymer. The blend consisted of the plasticizer and UV curable acrylic base polymer. increasing weight % of the plasticizer increases the adhesion both at 0 and 10 degrees Fahrenheit.

| | | | | 90° Peel | |
|---|---|---|---|---|---|
| | | | 90° Peel | adhesion | |
| | Transfer Film, | Cure | adhesion | at 10° F. | Shear to |
| | or laminated to | Dosage | Specification | to OSB | Steel |
| Adhesive | Substrate | (mJ/cm2) | (Lbs) | (Lbs) | (minutes) |
| Ac250/Admex 525 = 90/10 | 8 mil Flashing | 50 | >1.5 | 1.43 | 3.7 |
| Ac250/Admex 525 = 90/10 | 8 mil Flashing | 70 | >1.5 | 1.53 | 5.0 |
| Ac250/Admex 525 = 90/10 | 8 mil Flashing | 90 | >1.5 | 1.24 | 8.0 |
| Ac250/Admex 525 = 90/10 | 8 mil Flashing | 120 | >1.5 | 1.11 | 16.6 |
| Ac250/Admex 525 = 88/12 | 8 mil Flashing | 50 | >1.5 | 1.40 | 1.5 |
| Ac250/Admex 525 = 88/12 | 8 mil Flashing | 70 | >1.5 | 1.47 | 3.0 |
| Ac250/Admex 525 = 88/12 | 8 mil Flashing | 90 | >1.5 | 1.47 | 4.7 |
| Ac250/Admex 525 = 88/12 | 8 mil Flashing | 120 | >1.5 | 1.40 | 8.3 |
| Ac250/Admex 525 = 86.5/13.5 | 8 mil Flashing | 50 | >1.5 | 1.74 | 1.4 |
| Ac250/Admex 525 = 86.5/13.5 | 8 mil Flashing | 70 | >1.5 | 2.87 | 2.0 |
| Ac250/Admex 525 = 86.5/13.5 | 8 mil Flashing | 90 | >1.5 | 1.84 | 3.3 |
| Ac250/Admex 525 = 86.5/13.5 | 8 mil Flashing | 120 | >1.5 | 1.94 | 3.5 |
| Ac250/Admex 525 = 83/17 | 8 mil Flashing | 50 | >1.5 | 2.55 | 0.8 |
| Ac250/Admex 525 = 83/17 | 8 mil Flashing | 70 | >1.5 | 2.41 | 0.5 |
| Ac250/Admex 525 = 83/17 | 8 mil Flashing | 90 | >1.5 | 2.52 | 1.1 |
| Ac250/Admex 525 = 83/17 | 8 mil Flashing | 120 | >1.5 | 1.75 | 1.5 |

The table below displays adhesions to various surfaces of a blend of Citroflex A-4 and UV curable acrylic base polymer at 14 wt % Citroflex A-4 cured at 120 mJ/cm2. The adhesive is aged one condition 150 F at 80% Relative humidity for 16 hours. A second aging condition of 36 hours at 150 Fat 60% Relative humidity for 36 hours. These aging conditions simulate several years of storage in a humid warehouse environment. Particularly of interest is if there is any plasticizer migration, this would severely reduce the adhesive performance. The adhesive was aged then applied to various surfaces shown below. The adhesive still has maintained the adhesions above the required specification at 10 F but also maintains the integrity at higher temperatures as shown by the Shear/Steel at 149 F and SAFT.

| | | UV Curable Acrylic | UV Curable Acrylic | UV Curable Acrylic |
|---|---|---|---|---|
| | | Base Polymer/ | Base Polymer/ | Base Polymer/ |
| | | Citroflex A-4 = | Citroflex A-4 = | Citroflex A-4 = |
| | | 86/14 Fresh | 86/14 Aged 16 hrs | 86/14 Aged 36 hrs |
| 90° degree | 10 F. OSB | 1.77 | 1.54 | 1.44 |
| peel adhesions | 10 F. Plywood | 4.77 | 4.45 | 3.89 |
| | 10 F. Anodized | 4.81 | 4.52 | 4.71 |
| | Aluminum | | | |
| | 0 F. OSB | 1.06 | 0.88 | 0.86 |
| | 0 F. Plywood | 4.68 | 3.57 | 3.79 |
| | 0 F. Anodized | 4.94 | 6.05 | 5.25 |
| | Aluminum | | | |
| | 73° F. OSB | 3.28 | 3.46 | 2.94 |
| | 73 F. Plywood | 5.55 | 5.42 | 5.75 |
| | 73 F. Anodized | 6.41 | 7.14 | 6.32 |
| | Aluminum | | | |
| | Shear/Steel | 33.7 | 18.7 | 27.2 |
| | at 73 F. | | | |
| | Shear/Steel | 12.2 | 9.5 | 8.7 |
| | at 149 F. | | | |
| | SAFT | 64.9 | 62.3 | 63.1 |

### UV Curing Examples

Ultraviolet (UV) spectrophotometry can measure the concentration of the photoreactive group (or photoinitiator) in UV curable adhesives such as AcResin 250 and AcResin 260 from BASF and therefore can be used for quantitative analysis. The λ max for AcResin 250 and AcResin 260 has been determined to be around 255 nm. In order to obtain the cold temperature performance, AcResin 250 or AcResin 260 can be modified with a low Tg plasticizer. It was found that the selection of plasticizer can play a role in the curing of the photoreactive group of the AcResin 250 and AcResin 260 polymer. If the plasticizer absorbs at 255 nm, it will compete with the photo reactive group in AcResin 250 or AcResin 260, thereby causing a reduction in UV curing.

Plasticizers Used in this Study:

| ID | Physical state | Functionality |
|---|---|---|
| Triacetin | Liquid | Ester |
| Citrofiex A4 | Liquid | Ester |
| Benzoflex 50 | Liquid | Ester containing benzoate |
| Pycal 94 | Liquid | Ether containing phenyl |

AcResin 250 is blended with various plasticizers at a ratio of 80/20 at 280° F. for 1 hr to ensure good dispersion. The adhesive blends and neat AcResin are coated onto a PET release liner to obtain adhesive thickness of 5 mil. The coated adhesive is cured under UV light to obtain a UVC dose of 167 mJ using a Puck.

The cohesive strength of various adhesive is shown in the following table.

| ID | Cohesive |
|---|---|
| AcResin 250 only | Good |
| 80% AcResin 250-20% Triacetin | Good |
| 80% AcResin 250-20% Citroflex | Good |
| 80% AcResin 250-20% Benzoflex | Poor |
| 80% AcResin 250-20% Pycal 94 | Poor |

The AcResin 250, 80/20 blend of AcResin 250/Triacetin, and 80/20 blend of AcResin 250/Citroflex A4 result in good cohesive strength. However, 80/20 blend of AcResin 250/Benzoflex 50 and 80/20 blend of AcResin 250/Pycal 94 result in poor cohesive strength.

The cured adhesives are laminated onto the quartz plate by hand for UV absorbance measurement. The absorbance of cured adhesive samples is measured at 255 nm using UV-Visible Spectrometer (Perkin Elmer Lambda 465 PDA) and the result is shown in the graph of FIG. 6

AcResin 250 has an absorbance of 1.0 and an addition of either Triacetin or Citroflex A4 does not seem to change the absorbance of the blended adhesive. This means that both Triacetin and Citroflex A4 are transparent to the UV curing process. As a result, the cohesive strength of the cured adhesive is good. On the other hand, both Pycal 94 and Benzoflex 50 have much higher absorbance (Pycal 94=1.7; Benzoflex 50=3.6) compared to neat AcResin 250 (absorbance=1). This means that both Pycal 94 and Benzoflex 50 are not transparent to the UV curing process. The presence of Pycal 94 or Benzoflex 50 plasticizer hinders the UV curing process. As a result, the cohesive strength of the cured adhesive is poor.

### Cold Temperature (CT) Formulation Adhesive Examples

### CT Example 1

83 parts of AcResin 260, manufactured by BASF, were charged to a planetary mixer preheated to 280° F. 17 parts of Citroflex A4 was added slowly to the mixer and the mixture was agitated for 30 minutes at 280° F. The mixture was then de-gassed and discharged into a 5 gallon pail. The resulting adhesive was homogenous, clear, and free of air bubbles.

The 5 gallon pail containing the adhesive was placed under a 5 gallon Pail Melter, Alta Pail II (Nordson Corporation) for UV-Hot Melt processing. The temperature of the Alta Pail was set at 220° F. to melt & pump the adhesive to an adhesive reservoir where the temperature was maintained at 220° F. The adhesive was then pumped from the adhesive reservoir to a slot die with a shim thickness of 16 mil. 5 mil adhesive was deposited onto a 76 lb polyclad release liner and passed thru a UV light chamber (H₊ bulb from Heraeus Corporation). The UVC dose was recorded by an EIT UV Puck II to be 90 mJ/cm2.

The inside of an 8 mil TPO based flashing backing film, MC900MJZ, manufactured by Charter NEX, was corona treated to yield surface energy of 40 dyne/cm2. The cured adhesive was laminated to the corona treated side of the Charter NEX film using a roller at 4.5 lb weight and the product was designated Cond 1.

### Standard Temperature (ST) Example 1

83 parts of AcResin 250, manufactured from BASF, were charged to a planetary mixer preheated to 280° F. 17 parts of Citroflex A4 was added slowly to the mixer and the mixture was agitated for 30 minutes at 280° F. The mixture was then de-gassed and discharged into a 5 gallon pail. The resulting adhesive was homogenous, clear, and free of air bubbles.

The 5 gallon pail containing the adhesive was placed under a 5 gallon Pail Melter, Alta Pail II (Nordson Corporation) for UV-Hot Melt processing. The temperature of the Alta Pail was set at 220° F. to melt & pump the adhesive to an adhesive reservoir where the temperature was maintained at 220° F. The adhesive was then pumped from the adhesive reservoir to a slot die with a shim thickness of 16 mil. 5 mil adhesive was deposited onto a 76 lb polyclad release liner and passed thru a UV light chamber (H₊ bulb from Heraeus Corporation). The UVC dose was recorded by an EIT UV Puck II to be 90 mJ/cm2.

The inside of an 8 mil TPO based flashing backing film, MC900MJZ, manufactured by Charter NEX, was corona treated to yield surface energy of 40 dyne/cm2. The cured adhesive was laminated to the corona treated side of the Charter NEX film using a roller at 4.5 lb weight and the product code was designated as Cond 2. The physical properties were tested.

### ST Example 2

Neat AcResin 260 was processed without any plasticizer Citroflex A4 the same way as Comparative 1 at a UVC dose of 90 mJ/cm2 at 5 mil in adhesive thickness. The adhesive was laminated to Charter NEX film and the product code was designated as Cond 3.

### ST Example 3

Neat AcResin 250 was processed without any plasticizer Citroflex A4 the same way as Comparative 1 at a UVC dose of 90 mJ/cm2 at 5 mil in adhesive thickness. The adhesive was laminated to Charter NEX film and the product code was designated as Cond 4.

The Table below shows the comparison between the CT formulation and ST Examples 1, 2, and 3.

| | CT | ST | ST | ST |
|---|---|---|---|---|
| | Example | Example 1 | Example 2 | Example 3 |
| Acrylic Polymer- | 83 | | 100 | |
| AcResin 260 | | | | |
| Acrylic Polymer- | | 83 | | 100 |
| AcResin 250 | | | | |
| Plasticizer- | 17 | 17 | | |
| Citroflex A4 | | | | |
| Required UVC | 90 | 90 | 90 | 90 |
| dose (mJ/cm2) | | | | |

The Table below shows the comparison between Flashing Tapes constructions

| Tape ID | Cond 1 | Cond 2 | Cond 3 | Cond 4 |
|---|---|---|---|---|
| Backing ID | MC900MJZ | MC900MJZ | MC900MJZ | MC900MJZ |
| Adhesive | 5 | 5 | 5 | 5 |
| Thickness (mil) | | | | |
| Adhesive | CT Example | ST EX. 1 | ST EX. 2 | ST EX. 3 |
| Formulation | | | | |

90° Peel adhesion on OSB was evaluated at 73° F. Tapes and panels were conditioned at 73° F. & 50% humidity for a minimum of 2 hours. Tapes were applied to panels at 73° F., rolled down on roll down machine, and finger pressure was applied to press tape into the OSB surface. Tapes were allowed to dwell on OSB panels for 20 minutes at 73° F. and 90° peel adhesion was measured at 73° F.

Shear was evaluated at 73° F. (PSTC 107/Procedure A). A 1″-wide strip of tape is applied to a standard steel panel under controlled roll down. Pressure is applied using either a mechanically operated 4½ lb. roller or a hand-operated, PSTC-approved 4.5 lb. rubber-covered roller. The panel is mounted vertically, a standard mass of 1 kg is attached to the free end of the tape, and the time to failure is determined.

The table below shows the data of 90 peel on OSB and shear on steel at 73 F for Cond 1-4.

| Tape ID | Cond 1 | Cond 2 | Cond 3 | Cond 4 |
|---|---|---|---|---|
| Adhesive | AcResin | AcResin | AcResin | AcResin |
| formulation | 260/Citroflex | 250/Citroflex | 260 | 250 |
| | A4 = 83/17 | A4 = 83/17 | | |
| 90 peel on OSB | 2.74 | 3.11 | 2.65 | 3.26 |
| (lb) at 73 F. | | | | |
| Shear/Steel | 269.1 | 7.6 | 381.2 | 1538.0 |
| at 73 F. | | | | |
| Shear Retention | 70.6 | 0.5 | NA | NA |
| (%) | | | | |

Comparing peel on OSB from Cond 1 to Cond 3, one can see that the addition of 17% plasticizer Citroflex A4 had little impact on peel on OSB when compared to neat AcResin 260. Similarly, comparing Cond 2 to Cond 4, one can see that the addition of 17% plasticizer Citroflex A4 had little impact on peel on OSB when compared to neat AcResin 250.

Shear retention of a plasticized polymer is defined as follows: Shear Retention (%)=Shear of Plasticized Polymer/Shear of Neat Polymer without a Plasticizer, where Plasticized Polymer=Mixture of Plasticizer Citroflex A4+AcResin 260 or 250 Polymer. Neat Polymer=AcResin 260 or 250

The shear/steel of neat AcResin 250 was about 4× that of the neat AcResin 260. Surprisingly, the shear/steel trend was opposite to what one would expect when blending 17% plasticizer Citroflex A4 with 83% of polymer, either AcResin 260 or AcResin 250. The shear of AcResin 250/Citroflex A4 was 7.6 mins, while that of AcResin 260/Citroflex A4 was 269.1 mins. The shear/steel of the AcResin 260/Citroflex A4 blend (Cond 1) was 35× that of the AcResin 250/Citroflex A4 blend (Cond 2). The shear retention for AcResin 260/Citroflex A4 was 70%, while that for AcResin 250/Citroflex A4 was only 0.5%.

Hot Shear at 150° F.

CT Formulation

82 parts of AcResin 260, manufactured from BASF, were charged to a planetary mixer preheated to 280° F. 18 parts of Citroflex A4 was added slowly to the mixer and the mixture was agitated for 30 minutes at 280° F. The mixture was then de-gassed and discharged into a 5 gallon pail. The resulting adhesive was homogenous, clear, and free of air bubbles.

The 5 gallon pail containing the adhesive was placed under a 5 gallon Pail Melter, Alta Pail 11 (Nordson Corporation) for UV-Hot Melt processing. The temperature of the Alta Pail was set at 220° F. to melt & pump the adhesive to an adhesive reservoir where the temperature was maintained at 220° F. The adhesive was then pumped from the adhesive reservoir to a slot die with a shim thickness of 16 mil. 5 mil adhesive was deposited onto a 76 lb polyclad release liner and passed thru a UV light chamber (H₊ bulb from Heraeus Corporation). The UVC dose was recorded by an EIT UV Puck II to be 80 mJ/cm2.

The inside of an 8 mil TPO based flashing backing film, MC900MJZ, manufactured by Charter NEX, was corona treated to yield surface energy of 40 dyne/cm2. The cured adhesive was laminated to the corona treated side of the Charter NEX film using a roller at 4.5 lb weight and the product code was designated as SL120. The physical properties were tested.

ST Formulation

86 parts of AcResin 250, manufactured from BASF, were charged to a planetary mixer preheated to 280° F. 14 parts of Citroflex A4 was added slowly to the mixer and the mixture was agitated for 30 minutes at 280° F. The mixture was then de-gassed and discharged into a 5 gallon pail. The resulting adhesive was homogenous, clear, and free of air bubbles.

The 5 gallon pail containing the adhesive was placed under a 5 gallon Pail Melter, Alta Pail 11 (Nordson Corporation) for UV-Hot Melt processing. The temperature of the Alta Pail was set at 220° F. to melt & pump the adhesive to an adhesive reservoir where the temperature was maintained at 220° F. The adhesive was then pumped from the adhesive reservoir to a slot die with a shim thickness of 16 mil. 5 mil adhesive was deposited onto a 76 lb polyclad release liner and passed thru a UV light chamber (H₊ bulb from Heraeus Corporation). The UVC dose was recorded by an EIT UV Puck II to be 120 mJ/cm2.

The inside of an 8 mil TPO based flashing backing film, MC900MJZ, manufactured by Charter NEX, was corona treated to yield surface energy of 40 dyne/cm2. The cured adhesive was laminated to the corona treated side of the Charter NEX film using a roller at 4.5 lb weight and the product code was designated as SL120. The physical properties were tested. A 1″-wide strip of tape is applied to a standard steel panel under controlled roll down. Pressure is applied using either a mechanically operated 4½ lb. roller or a hand-operated, PSTC-approved 4.5 lb. rubber-covered roller. The panel is mounted vertically in an oven at 150° F., a mass of 0.5 kg is attached to the free end of the tape, and the time to failure is determined

The Table below shows the comparison between the CT Formulation and the Universal Formulation.

| | CT Example | ST Example |
|---|---|---|
| Acrylic Polymer-AcResin 260 | 82 | |
| Acrylic Polymer-AcResin 250 | | 86 |
| Plasticizer-Citroflex A4 | 18 | 14 |
| Required UVC dose | 80 | 120 |
| (mJ/cm2) | | |

The table below shows the comparison between Flashing Tapes constructions

| Tape ID | SL120 | SL100 |
|---|---|---|
| Backing ID | MC900MJZ | MC900MJZ |
| Adhesive Thickness (mil) | 5 | 5 |
| Adhesive Formulation | CT EX. | ST EX. |

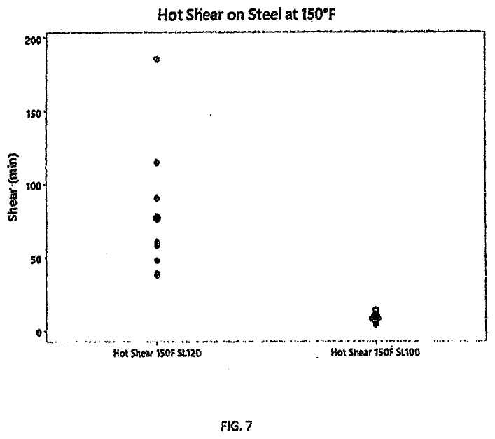

From FIG. 7, one can see that SL120 has hot shear at 150° F. about 7× that of the SL100. The surprisingly higher hot shear for the SL120 (using the CT EX.) indicates a synergistic effect of the plasticizer, Citroflex A4, with the polymer AcResin 260.

Permeability

78 gsm of PP non-woven was laminated using 3, 5 and 8 mils of adhesive formed from 82 parts AC-Resin 260 and 18 parts Citroflex A4 in accord with the procedural manufacturing steps outlined above. The permeability of the uncoated non-woven as well as the non-woven coated with adhesive was measured using ASTM E96 B (Wet cup method). The average permeability results are shown below:

| Adhesive Thickness, | Average permeability, |
|---|---|
| mils | Perm |
| Un-coated | 600 |
| 3 | 40 |
| 5 | 28 |
| 8 | 16 |

The exemplary embodiments have been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

1. An adhesive composition comprising:
a UV curable acrylic polymer having a molecule weight between about 150,000 and 300,000 grams/mol; and
between 1-50 wt. % of a plasticizer having a molecular weight between about 200 and 1000 grams/mol.

2. The composition of claim 1 wherein said plasticizer is substantially transparent to UV radiation.

3. The composition of claim 1 wherein said plasticizer is at least substantially free of aromatic rings.

4. The composition of claim 1 wherein said plasticizer is at least substantially non-volatile.

5. The adhesive composition of claim 1 for use in building construction materials selected from permeable and impermeable barriers, flashing tape, sealing tape, and double coated tape, said adhesive being applied to the building material in a repeating or random pattern that covers less than 100% of a surface.

6. (canceled)

7. The adhesive composition of claim 1 comprising a UV curable polymer having a molecular weight of at least 150,000 g/mol with a λ max of 200-360 nm and a plasticizer that absorbs less than 5% of the UV radiation at 200-360 nm.

8. An adhesive composition comprising a UV curable polymer having a number average molecular weight Mn between 50,000 and 65,000 grams/mol and/or a weight average molecular weight Mw between 100,000 and 300,000 grams/mol in combination with between 2-30 wt. % of a plasticizer having a molecular weight between about 200 and 1000 grams/mol, said plasticizer being substantially transparent to UV radiation between 200 and 360 nanometers.

9. An article comprising seaming tape, flashing tape, vapor permeable and impermeable weather resistant barrier, or roof underlayment including the pressure sensitive adhesive of claim 8.

10. The article of claim 9 being formed by transfer coating the cured UV pressure sensitive adhesive onto said article.

11. The article of claim 9 being formed by direct coating and curing the pressure sensitive adhesive on the article.

12. The article of claim 10 wherein a transfer coating substrate forms a release liner on the article.

13. The article of claim 10 wherein the transfer coating substrate is a sacrificial layer that is separated from the adhesive after UV curing and replaced with a release liner of an alternate composition.

14. The article of claim 10 wherein the article is treated to allow self-winding with a transfer coating substrate being removed after cure.

15. An adhesive composition comprising a UV curable polymer having a shear viscosity (Pa·s) of less than 17 at 240° F. and less than 10 at 280° F. in combination with 2-30 wt. % of a plasticizer having a molecule weight between about 400 and 600 grams/mol.

16. An article comprising flashing tape, vapor barrier, or roof underlayment including 100% adhesive coverage on an adhesive inclusive surface, the adhesive being described in claim 8, wherein the article is vapor permeable after attachment to a building.

17. The article of claim 16 having an adhesive thickness of at least 8 mils and a permeability using ASTM E96B of at least 10.

18. A transfer coating substrate comprised of paper, polymer or other material, said transfer coating substrate including the adhesive of claim 8, said transfer coating substrate being one of self-wound or linered for use as an adhesive transfer product.

19. The adhesive composition of claim 1 comprising:
a UV curable acrylic polymer having a molecule weight between about 170,000 and 250,000 grams/mol; and
between 8-20 wt % of a plasticizer having a molecular weight between about 400 and 600 grams/mol.

20. The adhesive composition of claim 7 comprising a UV curable polymer having a λ max of 250-260 nm and a plasticizer that absorbs less than 5% of the UV radiation at 250-260 nm.

21. The adhesive composition of claim 8 comprising a UV curable polymer having a number average molecular weight Mn between 50,000 and 65,000 grams/mol and/or a weight average molecular weight Mw between 100,000 and 200,000 grams/mol in combination with between 5-25 wt. % of a plasticizer having a molecular weight between about 200 and 600 grams/mol.
